(19) United States
(12) Patent Application Publication
(10) Pub. No.: US 2023/0089572 A1
(43) Pub. Date: Mar. 23, 2023

(54) COMPUTER-IMPLEMENTED METHODS AND SYSTEMS FOR WORKFLOW GENERICIZING, ASSIGNMENT AND EXECUTION

(71) Applicant: Waitron Inc. d/b/a Meridio, New York, NY (US)

(72) Inventors: Bobby Sain, New York, NY (US); Tom Grace, Brooklyn, NY (US)

(21) Appl. No.: 17/483,376

(22) Filed: Sep. 23, 2021

(51) Int. Cl. G06Q 10/10; G06Q 10/06

(52) U.S. Cl. CPC G06Q 10/1057; G06Q 10/063112; G06Q 2220/00

(57) ABSTRACT

A computer-implemented method comprises loading information of a plurality of products, a plurality of employees of an organization and qualifying information for a plurality of sales agents into a database. A token data structure may be generated that is unique to a product, to an employee and to qualifying information of one or more sales agents authorized to sell the product to the employee. The token data structure may then be encrypted and sent to a load balancing scheduler, which may then select and assign the decrypted token data structure to one of a plurality of available and qualified virtual seats. Each qualified and available virtual seat may be configured to be occupied by any available sales agent whose qualifying information matches the qualifying information in the generated token data structure. The assigned token data structure may then be decrypted and the database accessed. Information that is related to the product and the employee specified by the decrypted token data structure may then be loaded into an enrollment interface with which a sales agent occupying the assigned virtual seat interacts to sell the product to the employee.

### BACKGROUND

Financial products such as investments or insurance have been primarily sold through the use of individual field agents on behalf of brokers or carriers. These field agents work on behalf of the financial institution or insurance carrier going door-to-door or individually calling potential customers to sell and enroll customers in the financial products that the broker or carrier manufactures.

Over time, it has become apparent that that it is more economical to target large groups of people through the engagement of business owners, instead of directly to the individuals themselves. Traditionally, the broker or insurance sales agent would first convince the business owner of the value of their services, emphasizing the benefits of their financial product toward recruitment and employee retention. Once the business owner is on board, the broker or sales agent would gain access to the business owner's employees to sell them the financial products or insurance benefits. The value to the employer is that this arrangement gives them a way to attract talent by offering additional value to employees and future hires, without raising expenditures.

Over time, financial brokers and insurance firms replicated what the carrier agents did at the worksite; namely, the marketing of benefits products, to ever larger numbers of employees. This had the advantage of introducing economies of scale into the process. Significantly, financial product brokers and insurance brokers can sell on behalf of any financial institution or carrier, not just the one for which they are an agent, which distinction enables the above-mentioned economies of scale.

As the insurance business evolved and competition grew, the process of selling and enrolling evolved into two distinct jobs: brokers who sold to the business owner to gain access, and the enrollment company, a new entrant into the field. The enrollment company devised methods for marketing and enrolling employees in the benefits programs that were sold by the insurance brokers. As competition in this space grew, the enrollment company required larger and larger pools of potential applicants to turn a profit. Such larger pools of applicants allowed the enrollment companies to achieve economies of scale, by spreading their expenses over a larger number of potential policyholders. The employees that worked for smaller companies were left behind and were not offered the advantageous financial and insurance products offered to larger concerns, as economics began to favor larger transactions. Entrepreneurs attempted to solve this problem by developing self-service software solutions. However, employees still require the personal attention from an agent to fully appreciate the value of the financial instruments and insurance products being offered—so software alone could not solve the technical problem. Therefore, there developed a need for an automated and computer-implemented solution that is equally efficient at servicing small and large groups of potential customers without, however, ignoring the need for personal, human contact to address the customer cares, concerns and questions. A technical solution to this technical problem ought to be sufficiently flexible to be readily adaptable to multiple carriers, financial institutions, financial or insurance products, and scalable from small and medium enterprises (SMEs) to large multi-national corporations employing tens of thousands of employees. As such issues are not unique to financial instruments and insurance products, such computer-implemented solution ought to be readily portable to sales in other fields that are amenable to automation yet require personalized, human attention.

### BRIEF DESCRIPTION OF THE DRAWINGS

FIG. 1 is a flow chart of a conventional method of connecting potential policy holders and sales agents.

FIG. 2 is a diagram of a system according to an embodiment.

FIG. 3 is a flowchart of a computer-implemented method and workflow according to one embodiment.

FIG. 4 is a diagram of computing device with which embodiments may be practiced. FIG. 4 also shows non-transitory storage media configured according to embodiments.

### DETAILED DESCRIPTION

A computerized workflow consists of an orchestrated and repeatable pattern of coded activities, enabled by the systematic organization of resources into computer-implemented processes that transform materials, provide services, or process information. Embodiments provide computer-implemented workflow methods and systems for financial product genericizing, assignment and execution. In particular, and within the context of recommending, providing and enrolling customer in insurance products, embodiments provide automation through highly flexible workflows, scale through a process of genericizing data structures, and consistent execution through standardization and load balancing to achieve technical solutions that are equally applicable across financial products, companies, and sales agents, while remaining wholly opaque to the end customers, who experience a wholly personalized experience, fully unaware of the industrial-scale back end automation.

Significantly, past experience in this field has driven the realization that the process of enrolling worksite employees in financial and insurance products requires that specific steps be taken to seamlessly integrate the best abilities and capabilities of both humans and computer systems to achieve scalability and profitability, while not sacrificing quality and customer satisfaction of the underlying enrollment process. Having examined these steps and requirements at length, it has become apparent that embodiments could employ innovative novel technologies to reinvent the process by which the business was enrolled. Significantly, it has been found that if the request for financial or insurance products and human expertise could be virtualized from the end individual employee through the use of an innovative and genericized token data structure, that token data structure could then be deployed through a virtual load balancing system. The load balancing system, in turn, could then be configured to dynamically assign the genericized token data structure to a selected virtual seat for unpacking, assignment and execution by a human sales agent or, for example, a software bot (e.g., an expert system or AI-powered) qualified or otherwise configured to sell that particular product to that particular employee at that particular location. Such a virtualization, load balancing and dynamic assignment, therefore, could then lead to the efficient sale of goods and services to any number of employees of any company, regardless of size. In this manner, whether a product is being sold to a dozen or at scale to tens of thousands of employees, the same computer-implemented process and workflow would be followed.

Significantly, the present computer-implemented methods, systems and devices are configured to make the fulfillment of insurance enrollments (for example, and without limitation) more efficient and scalable by replacing the one-to-one order taking system that is traditionally employed to sell insurance, with a virtualized many-to-many load-balancing system that uses encrypted and uniformly-configured token data structures to package information related to a potential policy holder and products available to that potential policy holder and match that packaged information with a unique virtual seat for unpacking and fulfillment; and to do so across any company size, product portfolio, or employee. The seat is “virtual” as it is not occupied by a named financial advisor or insurance product sales agent. The virtual seat, instead, represents a potential assignment of a token data structure to one or many sales agents having the requisite and predetermined skill set, knowledge base, authorization and availability (e.g., available time slot), as developed further herein below.

Traditionally, profitability in enrolling customers has increased geometrically along with the size of the company; that is, with the number of available customers. Indeed, the greater number of potential customers, the more profitable the enrollment process becomes, as the time-consuming and costly sales agent training can be amortized over a much greater number of enrollments. Conversely, enrolling customer of smaller-scale companies has traditionally been less profitable, as there are fewer potential enrollees over which to amortized the cost of training sales agents and the sheer cost of making highly trained humans sit idle, waiting for customer contacts. The present embodiments, however, by employing this tokenized data structure and this virtual load-balancing methodology technical solutions, are able to economically service and scale small business insurance enrollments, which have traditionally been a revenue-losing proposition for brokerages, carriers, and insurance enrollment companies.

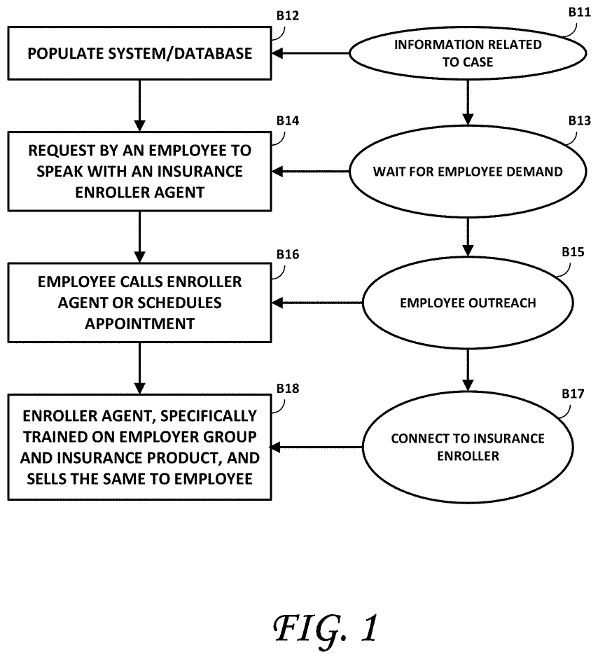

FIG. 1 shows a conventional method of selling financial products to potential customers r enrolling potential insurance product customers. As shown at block B12 in FIG. 1, a computer system and/or database is populated with all of the information, shown at B11, an enroller may require to successfully sign up a potential enrollee. This includes, without limitation, the employees' personal information, company information, details of the financial or insurance products, pricing, availability, open enrollment dates and the like. A number of sales agents are hired and trained on the particular products being offered by the employer, pricing structures, plan requirements, deductibles, benefits and the like. These sales agents then stand by, waiting to be contacted. As shown in FIG. 1, once this information is loaded and sales agents trained on this customer and products are standing by, the agent waits, as shown at B13, for the employee to reach out to the agent, as shown at B14. When the employee/potential enrollee reaches out as shown at B15, contact is made and/or an appointment is scheduled, as shown at B16. At the scheduled time, as shown at B17, the employee contacts the enroller agent, whereupon the agent and employee interact, apply for and enroll in the offered insurance program, buy the offered financial product, subscribed to the offered services and the like, as suggested at B18. This is highly inefficient and unscalable. Specifically, this solution requires determining the number of sales agents to assign to such enrollment, training them on this combination of employer/employee/product, reaching out to employees, informing them of the availability of such sales agent, waiting for the customers to initiate contact and hoping that the specifically-assigned sales agent can close a sufficient number of sales to not lose money in the process. As a result of this structure, many sales agent are idle for much of the time, waiting for potential enrollees to contact them on their schedule, thereby increasing costs and reducing both commissions and profitability.

As suggested by FIG. 1, enrollment companies are required to gather many pieces of data upfront to ensure the employee is buying only the products that are available from their employer. Enrollers or sales agents are trained on the specific information related only to that one enrollment, effectively employing that enroller to work only for that one company for a predetermined period of time. This is why traditional enrollment companies are not a cost-effective solution to enroll employees of small companies; the single enroller working one individual company is a money-losing proposition, when commissions from insurance sales are not enough to cover the cost of the insurance expert and the additional overhead that the enrollment company has.

For example, a 10 person company and a 1,000 person company may be compared to assess the advantages of the present tokenized load-balancing computer-implemented methods and systems. Let us assume that the average income for employees of both companies is the same, and that both companies are interested in providing a new benefits package to their employees. Traditionally, once engaged by the broker, the enrollment company will take the following steps to service to both the broker and the enrollment company itself:
1. Sign an agreement with the broker, making promises to deliver the following:
   a. a Benefits Administration system with the built out products necessary for enrollment of the broker's client's employees;
   b. paperwork appointing the enrollment company and the broker to the carrier to ensure the broker and the enrollment company are allotted commissions for the sale of products made during the enrollment process;
   c. agreement on marketing materials that the enrollment company will use to notify the employees of the available benefits information;
   d. the contracting of individual licensed insurance experts for a predetermined period of time to facilitate the fulfillment of the order when an end customer (an employee) is ready to buy products during the insurance enrollment; and
   e. the training and matching of insurance experts time to an end employee who is interested in learning more about the products that have been made available to them.

Today, the larger case is clearly more profitable because each step along the way is done by a human. Therefore, the cost of that human becomes more cost-effective as more insurance products are sold to a larger group of employees, and more commissions are earned.

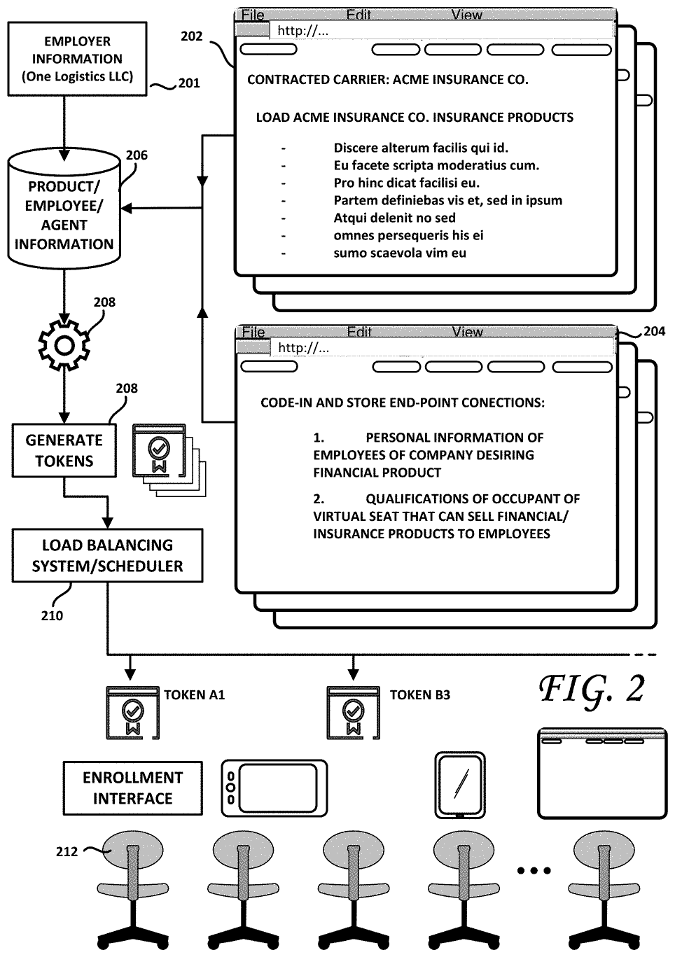

The present computer-implemented systems and methods change the above-described paradigm much the above steps, and then generates and allocates a unique identifier of the employee to a virtual token data structure to be unpacked by a virtual load balancing and distribution system. According to one embodiment, a token data structure may be constructed starting at the carrier, and working down to the employee. As shown in FIG. 2, an internal team may build out a product stack based on the carrier/provider/administrator after an agreement is executed with them and this product stack may be assigned a unique identifier. Reference 202 in FIG. 2 shows an exemplary loading web interface, showing the name of the contracted carrier and the (in this implementation) insurance products to be sold. As suggested by the multiple web pages shown at 202, the same or similar product information may be loaded for a great many different carriers; providers and administrators, each being assigned a unique identifier. The gathered information may then be used to populate one or more databases selectively accessible over a. computer network. For example, such databases may be maintained by Amazon's AWS® or Microsoft Azure®, to name but a few possibilities.

Significantly, in the present embodiments, insurance/financial experts are trained, not on the individual companies, but on the present tokenized distribution system, and are not assigned to one individual company, but are trained to process requests pointed to by the generated token data structures, thereby enabling processing requests of employees of any company for any product portfolio at any time. The system's unique components and the tokens (the structure and/or format thereof remaining the same across employees, employers, and products or p a s nable the automation of the various parts of the sunk-costs which have traditionally made enrollments cost prohibitive.

In FIG. 2, end-point connections may be coded and entered, to facilitate the distribution of those products using automated messaging systems and an order taking tool for fulfillment. According to embodiments and as shown at 204 in FIG. 2, the end-point connections may be defined as the two ends of the insurance or financial product transaction: 1) employees wanting to buy insurance or some other financial product, 2) the sales agent occupant of the virtual seat 210 that sells the financial or insurance product using the information retrieved from the database 206 based on the information in the token data structure delivered to that virtual seat.

Communications between these two end-point connections may be carried out through a variety of channels. For instance, in one implementation, Twilio SMS APIs may be used to time delivery of personalized text messages, voice routing using the AWS' Connect system, dynamic landing pages built on Webflow, and a scheduled automated emailer using AutoPilot. Other communication channels may be used.

According to one embodiment, when an insurance or financial expert is requested by an employee and received by the system, the database 206 into which all product and end-point connection information was loaded may be accessed (e.g., over a computer network) and a genericized token data structure may be generated—or, if previously-generated, accessed. The token data structure is said to be genericized (or standardized), as the information therein is loaded and packed in the same manner, order and configuration, irrespective of the contracted carrier/provider or administrator, company, insurance or financial product, potential enrollee and/or sales agent that will handle the sale. According to one embodiment, the token data structure may be encrypted, which is beneficial for both end-point connections. Indeed, the carrier/provider or administrator's product details may include confidential or need-to-know information (confidential HR information, product plans, pricings, incentives), and the potential enrollee's personal and professional information (e.g., age, marital status, income, medical information, etc.) should also be safeguarded against potential misuse. In one embodiment, the token data structure may be configured as, e.g., an n-bit (256-bit in one exemplary implementation) encrypted data structure that remains encrypted, at least during transit over public channels. Virtual Private Networks (VPNs) may also be used to further encrypt the communication channel over which the encrypted token travels.

According to one embodiment, a token data structure may be constructed (as represented in FIG. 2 at 208) as follows. For the purposes of this explanation, the products offered in this example are a combination of health insurance, life insurance, and dental insurance. Other financial or other products may also be used, as the situation indicates. In one illustrative example, a unique carrier identifier of “A” is used to represent carrier Acme Insurance Company. As companies or organizations sign up to provide Acme Insurance Company benefits to their employees or members, those companies are each assigned a unique company identifier, the existence of which also signifies that their employees have been grantxd the ability to sign up for the benefits offered by Acme Insurance Company. Companies such as Acme Insurance Company as shown at 202 may reach the present system through multiple channels, including direct marketing, from a broker or from the carrier itself. The exemplary employer One Logistics LLC, shown at 201 in FIG. 1, whose employees wish to enroll in or purchase one or more of Acme Insurance Company's products, may then be identified using a unique company identifier “1”. As also shown at 204, the employer “1” may provide an employee census including relevant HR information, which is then also uploaded and stored in the remote database 206. Each employee of company “1” may then be assigned a unique employee identifier to match them with the census and the employer. For example, the unique employee identified may be configured as part of an index into a table of employee information for that employer stored in the database 206. For example, an employee John Doe may be assigned the unique employee identifier “JD. In this manner, a token data structure may be constructed, as suggested at 208, having “A1JD” as attributes and the fully qualified network location of the relevant record within database 206, which enables access, over the computer network, to all the relevant information from the database(s) 206 to complete the sale of the intended product to the identified employee. Such an “A1JD” token data structure identifies the carrier/provider “A”, the employer “1” and the employee “JD”. The sales agent to whom the token data structure is distributed may open the token data structure, which is then decrypted and unpacked, and the information coded therein may be used to access the database 206 and/or other databases of information over a computer network, to enable to sales agent to see all of the products offered by carrier A that the company 1's employee JD is entitled to purchase. Such access and retrieval may tigger the retrieval of further detailed information regarding available plans, sales incentives, and any other available information that is required or would be useful to the sales agent as he or she pitches A's products to company 1's employee JD. Note that, although encrypted, according to one embodiment, no substantive, personally-identifiable or confidential information need be included in the token data structure. The use of the token data structure, according to one embodiment, may be limited to accessing the information necessary to effectuate the sale, subject to appropriate network security, permissions and access controls. Therefore, even if one or more token data structures were to be intercepted by an interloper while en route to an agent, and even if the interloper succeeded in decrypting the token data structure, no useful information would be retrieved from the token data structure itself. Additional obfuscation or transformations may be carried out on the token data structure, to further mask the information being carried.

Now that the token data structure has been formed, as detailed above and as suggested at 208 in FIG. 2, it must be assigned to one or more sales agents in an efficient manner, to best serve both the end-point customer, the company and the sales agent's employer(s). Toward that end, recall that in this example, One Logistics LLC has authorized the marketing of the Acme benefits and plans to their employees, including John Doe. In one implementation, John Doe is sent marketing messages across different channels with the goal of getting John to a landing page of a website. When John clicks on the link to go to the landing page, the landing page identifies John Doe, generates or retrieves the corresponding token data structure (token A1JD) and may load, for example, products from Acme Insurance Company (identified by the token data structure), One Logistics LLC as the John Doe's employer (also identified by the token data structure) and an appointment scheduling functionality, included in reference 210 in FIG. 2. The scheduling system 210 then looks at the token data structure's unique identifiers and presents to John Doe with available time slots of sales agents who are qualified and available to service A1JD's request—or puts the two into immediate contact with one another. For instance, a sales agent that is qualified to take up token A1JD would be a licensed insurance agent that is appointed to Acme Insurance Company in the state in which One Logistics LLC is located. indeed, the appointment of a licensed insurance agent is required for the purposes of selling group insurance on behalf of that unique carrier (in this case, Acme Insurance Co.). This reduces the pool of available sales agent to only those qualified, by skill set, licensure and availability to make the sale. Note the sales agents are usually qualified to sell the products of more than one carrier to the employees of more than one company at any given time. By pooling such sales agents and genericizing the token data structures across companies, employees, products and sales agent qualifications, it becomes highly likely that a qualified sales agent will be available at the time of the employee's choosing and that, conversely, the sales agents' available time slots will be efficiently filed. This is because the sales agent is no longer tied to a single company and a single portfolio of financial or insurance products at any given time, thereby leveraging skill sets and licensure of many agents instead of the finite time of a specified number of sales agent being deployed to service the requests of employees of a single company. Generally, however, each state regulates the sales of such products differently, so a sales agent typically needs to be licensed in the state in which the company (in this case, One Logistics LLC) resides in order to service the request.

Returning to the example at hand, John Doe then confirms his preferred appointment time slot, from among those presented to him, that best fits his schedule. According to one embodiment, at the day and time of the appointment, the load balancing and scheduling system 210 hands-off the token “A1JD” to a customer relationship manager (CRM) software for unpacking. The unpacking system looks at the unique variables associated with that token, retrieves or otherwise accesses the corresponding information from the database(s) 206 and presents, via a graphical user interface of an enrollment interface, a plain language version of the information identified or pointed to by the token data structure, for the purposes of enabling the sales agent to sell to John Doe the products of interest to him. Further developing this example, the unpacking of the “AIM” token data structure may result in the agent being presented with information including, for example:

Employee: John Doe
i. Age: 51
ii. Sex: Male
iii. Income: $51,000
iv. Marital Status: Married
v. Dependents: 2 Children

Company: One Logistics LLC
i. Insurance Carrier: Acme Insurance Company
ii. Products: Fleilth Insurance, Life Insurance, Dental Insurance

When John Doe and the selected agent to which the load balancing delivered the token connect over the phone (or other audio/video/text-based communication modality) at the appointed date and time, the selected agent knows everything necessary about John Doe and the specific products made available to him to service his request. The agent may then open a benefit administration system page to enter John's order based on what the agent sells to John. If the call is cut off, if John needs to schedule another appointment, or if the sale is not concluded in that one interaction, John (or the agent) may reschedule John for another time in the future. In that case, the token A1JD may updated and repacked, as appropriate, and may reassign John another agent in the future depending on the availability of the agent and the parameters that meet A1JD's requirements. Note that the token may be updated before being repacked and re-encrypted, based upon any preferences or choices (i.e., specific financial or insurance products of interest made by John during his first interaction. For example, John may have decided on life and health insurance products, but may still be on the fence about purchasing dental coverage. Such would be reflected in the updated token data structure such that the next agent selected by the virtual load balancing system (which may or may not be the same agent as in the first interaction) to which the updated token data structure is delivered can seamlessly begin where the previous interaction left off.

The utility and advantages of the present embodiments become more pronounced at scale, across multiple carriers and employers and employees. Consider the following example. A corporation that wants to communicate benefits from three carriers to its 15,000 employees across eight divisions. The token for one employee may include the following aggregate identifier: ACM7JED3. Such a token, when decrypted and unpacked, may enable an agent access to the following information:

Employee: John Edward Doe III
i. Age: 36
ii. Income: $87,000
iii. Marital Status: Single

Company: Myers Grocery Eastern Division VII LLC

Insurance Carriers:
i. Acme Insurance Company,
ii. Colonial Life,
iii. Mass Mutual

Products: Health, Term Life, Whole Life

In this example, a carrier licenses the present system to be their virtual insurance sales solution. The token data structure for that carrier on the system could also include a broker, which would allow the tracking of sales for the broker and their engagements. The token data structure could be configured to reflect all of this information in the aggregate and include at least the following parameters/identifiers: ACM7JED3-ME2. The token may be constructed as shown below:

Employee: John Edward Doe III (XXXJED3-XXX)
Age: 36
Income: $87,000
Marital Status: Single

Company: Myers Grocery Eastern Division VII LLC (XXX7XXXX-XXX)

Insurance Carriers:
Acme insuranceCompany,
Colonial Life,
Mass Mutual

Products: Health, Term Life, Whole Life (ACMXXXXX-XXX)

Broker: Mary Louise Ellen (XXXXXXX-ME2)

Using a token data structure constructed as disclosed herein, when an employee of a company reaches the sales landing page, the system automatically constructs or accesses the corresponding token data structure, such that the landing page, load balancing and scheduling system already has a great deal of information on the employee, as it the employee were a well-known, pre-existing client. Embodiments bypass the broker, the traditional distribution pipeline, the payroll administration and all of the overhead costs that are required to support such an inefficient legacy system. According to one embodiment, the present system can track individual employees across multiple employers and carriers. So, in the future, when an employee returns to purchase other products, the employee's information and past purchase history may be known a priori even if the person changed employers in the interim. The present computer-implemented methods and systems enable efficient allocation of sales agents' tune. For instance, one insurance agent may have 16 appointments scheduled for the day. Each of the 16 appointments could be for different employees of different companies, each interested in purchasing products from different carriers. For each appointment, the format of the information accessed for each the same appointments is the same, and presented to the sales agent in the same manner, through a single, unified user interface.

The load balancing system/scheduler 210 may be configured to carry out an assignment of token data structures to sales agents according to any number of parameters, so as to most efficiently service client requests and to make best uses of sales agents' time, qualifications, availability, time zones and the like.

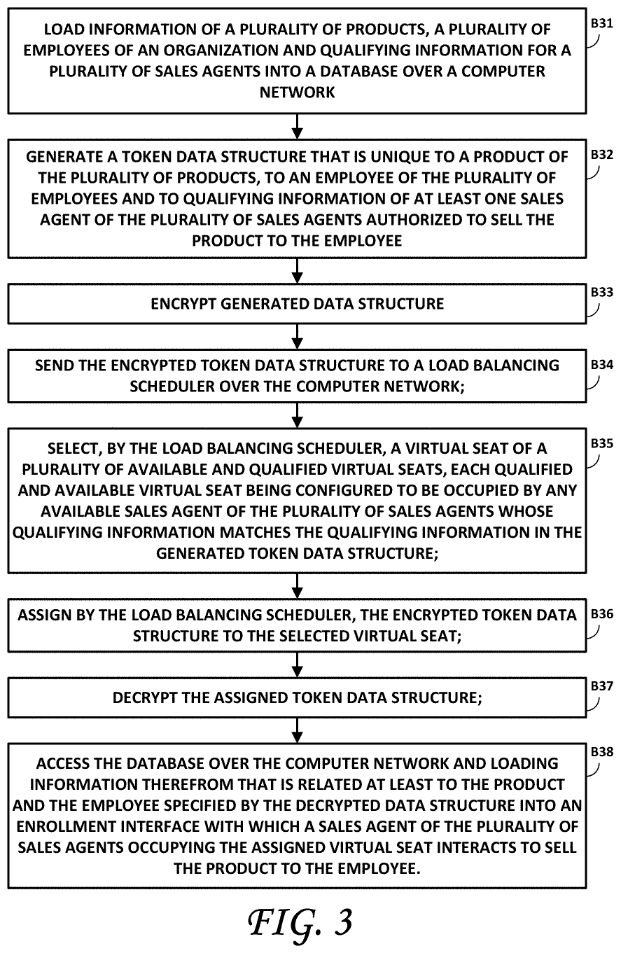

One embodiment, therefore, is a computer-implemented method. The computer implemented method, according to one embodiment, may include or incorporate workflows or like processes in any industry and more particularly in industries where jobs can be encapsulated in a standardized token data structure for load-balanced assignment to workers. In one implementation, as shown in FIG. 3, the computer-implemented method may comprise, as shown at block B31, loading information of a plurality of products, a plurality of employees of an organization and qualifying information for a plurality of sales agents into a database such as shown at 206 in FIG. 2, over a computer network. In one embodiment, the products may be or include financial instruments, financial products, insurance products, recurring services and subscriptions and the like. The information may include information relating to plans, rules, requirements, pricing, premiums and/or any information that would be considered to be material by both employer, the employee and the seller or seller's agent to complete the underlying transaction. As shown at B32, a token data structure may be generated that is unique to a particular product of the plurality of products, to a particular employee of the plurality of employees and to qualifying information of one or more sales agent of the plurality of sales agents authorized to sell the product to the employee. Functionally, each generated token data structure may be configured to enable the retrieval of specific information from the database 206 that is sufficient to enable a qualified sales agent to sell one or more products to a designated employee of the organization. The token data structure may be configured for a single product-employee combination or may be configured for multiple products that may be offered by a sales agent qualified to sell such products to a single employee. A next token data structure generated may be for an entirely different product, for a different employee of a different organization, to be offered for sale by sales agents having entirely different qualifications. As the sale of, e.g., financial and insurance products is highly regulated, a sales agent qualified to sell one product to an employee in one jurisdiction may not be authorized to sell the same financial or insurance product to another employee located in a different jurisdiction. According to one embodiment, and to efficiently feed potential sales to available and qualified sales agents, therefore, the format of the generated token data structure is the same or substantially the same irrespective of product, employee, organization, jurisdiction, to name but a few parameters.

In use, the generation of the token data structure may be triggered by an employee contacting the sales agent, presumably to inquire about a financial or insurance product, such as may occur during an open enrollment period in the case of a health insurance product. Such contact may be prompted by the employee being sent marketing messages (emails, phone calls, electronic messages, etc.) across different channels with the goal of inducing the employee to visit a landing page of a website. When the employee clicks on a predetermined link sent to him or her, the accessed landing page identifies the employee, and generates the token data structure or retrieves a pre-generated token data structure. Such a token data structure may be configured to load or allow access to, for example, products from a specific seller of such products to the employee, as specified by the employee's employer, also identified by the token data structure. According to one embodiment, the loading of the information derived from or accessed with the aid of, the token data structure may enable the system to establish an appointment for the employee and the sellers agent to speak at a time convenient to the employee and/or to connect the two immediately.

As called for at B33, the generated token data structure may be encrypted, as discussed above. Any encryption protocol may be adopted, including PGP, TLS/SSL, IPsec and SSH, for example. As shown at B34, the encrypted token data structure may then be sent to a load balancing scheduler 210 over the computer network. As noted above, the packet transport layer itself between the database 206 and the load balancing scheduler 210 may itself be encrypted, as is well known.

The load balancing scheduler 210 may then be configured, as shown at B34, to select a virtual seat (as graphically suggested at 212 in FIG. 2) of a plurality of available and qualified virtual seats, each qualified and available virtual seat being configured to be occupied by any available sales agent of the plurality of sales agents (human or otherwise) whose qualifying information matches the qualifying information in the generated token data structure. According to embodiments, “virtual seats” are agnostic to the particular product, employee, employer and to any particular sales agent. Such virtual seats may be configured to encompass, for example, any available time slot of any sales agent that is qualified (and authorized by appropriate state licensing, for example) to sell the product to the employee, irrespective of the particular product, employee or employer.

As shown at B35, the load balancing scheduler 210, according to present computer-implemented method may be configured to assign the encrypted token data structure to the selected virtual seat 212. According to one embodiment, the assignment may be made on the fly, to a pool of available and qualified sales agent, with the available first sales agent accepting being assigned the potential sales opportunity. According to another embodiment, assignments may be made automatically by the load balancing scheduler 210, which can also be configured to manage the sales schedule of the qualified sales agents who, at the appointed day and time, would contact the employee to make the sale.

Block B37 then calls for decrypting the token data structure. For example, such may be carried out contemporaneously with the contact by the sales agent with the employee, or shortly beforehand. Lastly and as shown at B38, the information present in the decrypted data structure may be used to access the database 206 over the computer network (e.g., the Internet and/or a private network). Thereafter, information stored in the database 206 pointed to or otherwise identified by the decrypted token data structure may be loaded into an enrollment interface for the sales agent—whether such enrolment interface is executing on a computer, tablet or mobile device, for example. The loaded information may include, according to one embodiment, information that is related at least to the product and the employee. In any event, the proper and sufficient information to enable the sales agent occupying the assigned virtual seat to sell the product to the employee may be loaded into the enrollment interface. The sales agent occupying assigned virtual seat may then proceed to sell the specified product to the employee.

When the sale is concluded, the token data structure may be again updated with the products and services purchased by the employee. This gives the enrollment company deploying the system according to embodiments with an up-to-date record of the employee's past purchases, preferences and future intentions, depending upon additional information that the sales agent may have entered into the enrollment interface during the sale. This information may be stored

Physical Hardware

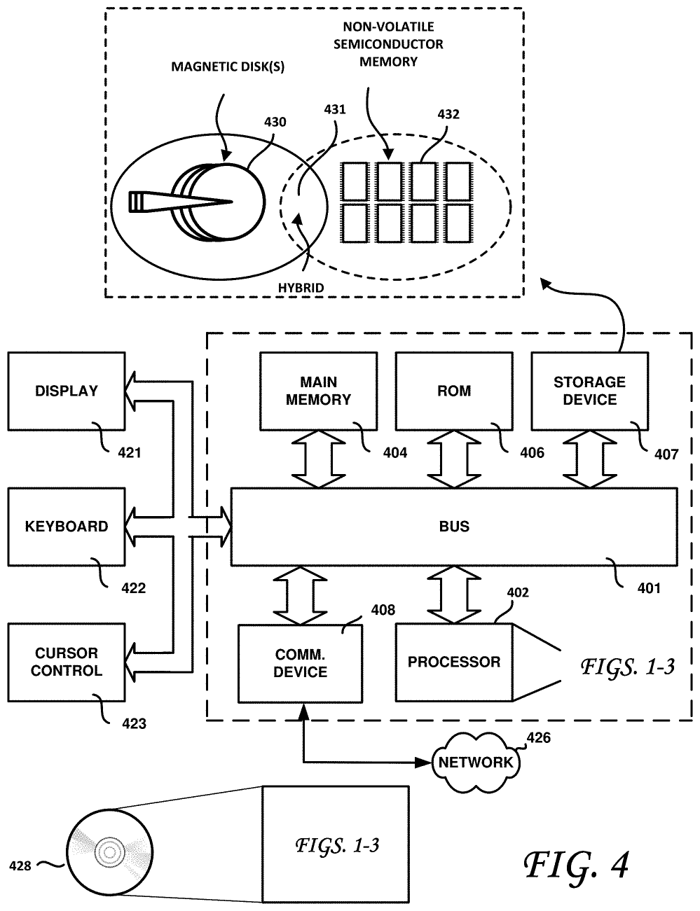

FIG. 4 illustrates a block diagram of a computing device with which embodiments may be implemented. The computing device of FIG. 4 may include a bus 401 or other communication mechanism for communicating information, and one or more processors 402 coupled with bus 401 for processing information. The computing device may further comprise a random-access memory (RAM) or other dynamic storage device 404 (referred to as main memory), coupled to bus 401 for storing information and instructions to be executed by processor(s) 402. Main memory (tangible and non-transitory, which terms, herein, exclude signals per se and waveforms) 404 also may be used for storing temporary variables or other intermediate information during execution of instructions by processor 402. The computing device of FIG. 4 may also include a read only memory (ROM) and/or other static storage device 406 coupled to bus 401 for storing static information and instructions for processor(s) 402. A data storage device 407, such as a magnetic disk and/or solid-state data storage device may be coupled to bus 401 for storing information and instructions such as would be required to carry out the functionality shown and disclosed relative to FIGS. 1-3. The computing device may also be coupled via the bus 401 to a display device 421 for displaying information to a computer user. An alphanumeric input device 422, including alphanumeric and other keys, may be coupled to bus 401 for communicating information and command selections to processor(s) 402. Another type of user input device is cursor control 423, such as a mouse, a trackball, or cursor direction keys for communicating direction information and command selections to processor(s) 402 and for controlling cursor movement on display 421. The computing device of FIG. 4 may be coupled, via a communication interface (e.g., modem, network interface card or NW) 408 to the network 426.

As shown, the storage device 407 may include direct access data storage devices such as magnetic disks 430, non-volatile semiconductor memories (EEPROM, Flash, etc.) 432, a hybrid data storage device comprising both magnetic disks and non-volatile semiconductor memories, as suggested at 431. References 404, 406 and 407 are examples of tangible, non-transitory computer-readable media having data stored thereon representing sequences of instructions which, when executed by one or more computing devices, implement aspects of the computer-implemented methods described and shown herein. Some of these instructions may be stored locally in a client computing device, while others of these instructions may be stored (and/or executed) remotely and communicated to the client computing over the network 426. In other embodiments, all of these instructions may be stored locally in the client or other standalone computing device, while in still other embodiments, all of these instructions are stored and executed remotely (e.g., in one or more remote servers) and the results communicated to the client computing device. In yet another embodiment, the instructions (processing logic) may be stored on another form of a tangible, non-transitory computer readable medium, such as shown at 428. For example, reference 428 may be implemented as an optical (or some other storage technology) disk, which may constitute a suitable data carrier to load the instructions stored thereon onto one or more computing devices, thereby re-configuring the computing device(s) to one or more of the embodiments described and shown herein. In other implementations, reference 428 may be embodied as an encrypted solid-state drive. Other implementations are possible.

Embodiments of the present invention are related to the use of computing devices to carry out the functionality disclosed herein. According to one embodiment, the methods, devices and systems described herein may be provided by one or more computing devices in response to processor(s) 402 executing sequences of instructions, embodying aspects of the computer-implemented methods shown and described herein, contained in memory 404. Such instructions may be read into memory 404 from another computer-readable medium, such as data storage device 407 or another (optical, magnetic, etc.) data carrier, such as shown at 428. Execution of the sequences of instructions contained in memory 404 causes processor(s) 402 to perform the steps and have the functionality described herein. In alternative embodiments, hard-wired circuitry may be used in place of or in combination with software instructions to implement the described embodiments. Thus, embodiments are not limited to any specific combination of hardware circuitry and software. Indeed, it should be understood by those skilled in the art that any suitable computer system may implement the functionality described herein. The computing devices may include one or a plurality of microprocessors working to perform the desired functions. In one embodiment, the instructions executed by the microprocessor or microprocessors are operable to cause the microprocessors) to perform the steps described herein. The instructions may be stored in any computer-readable medium. In one embodiment, they may be stored on a non-volatile semiconductor memory external to the microprocessor or integrated with the microprocessor. In another embodiment, the instructions may be stored on a disk and read into a volatile semiconductor memory before execution by the microprocessor.

Portions of the detailed description above describe processes and symbolic representations of operations by computing devices that may include computer components, including a local processing unit, memory storage devices for the local processing unit, display devices, and input devices. A command as the term is used in this disclosure may correspond to a high-level directive from a client process and may result in one or more computers executing multiple operations. An operation may include a single machine instruction. Furthermore, such processes and operations may utilize computer components in a heterogeneous distributed computing environment including, for example, remote file servers, computer servers, and memory storage devices. These distributed computing components may be accessible to the local processing unit by a communication network.

The processes and operations performed by the computer include the manipulation of data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements.

A process, such as the computer-implemented methods described and shown herein, may generally be defined as being a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind, however, that these and similar terms should be associated with appropriate physical quantities for computer commands, and that these terms are merely conventional labels applied to physical quantities that exist within and during operation of the computer.

It should also be understood that manipulations within the computer are often referred to in terms such as adding, comparing, moving, positioning, placing, illuminating, removing, altering and the like. The commands described herein are machine operations performed in conjunction with various input provided by a human or artificial intelligence agent operator or user that interacts with the computer. The machines used for performing the operations described herein include local or remote general-purpose digital computers or other similar computing devices.

In addition, it is to be noted that the programs, processes, methods, etc. described herein are not related or limited to any particular computer or apparatus nor are they related or limited to any particular communication network architecture. Rather, various types of general-purpose hardware machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

While certain example embodiments have been described, these embodiments have been presented by way of example only and are not intended to limit the scope of the embodiments disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the embodiments disclosed herein. Accordingly, the scope of the present disclosure is intended to be defined only by reference to the appended claims.

1. A computer-implemented method, comprising:
loading information of a plurality of products, a plurality of employees of an organization and qualifying information for a plurality of sales agents into a database over a computer network;
generating a token data structure that is unique to a product of the plurality of products, to an employee of the plurality of employees and to qualifying information of at least one sales agent of the plurality of sales agents authorized to sell the product to the employee;
encrypting the generated token data structure;
sending the encrypted token data structure to a load balancing scheduler over the computer network;
selecting, by the load balancing scheduler, a virtual seat of a plurality of available and qualified virtual seats, and assigning the encrypted token data structure to the selected virtual seat, each qualified and available virtual seat being configured to be occupied by any available sales agent of the plurality of sales agents whose qualifying information matches the qualifying information in the generated token data structure;
decrypting the assigned token data structure; and
accessing the database over the computer network and loading information therefrom that is related at least to the product and the employee specified by the decrypted token data structure into an enrollment interface with which a sales agent of the plurality of sales agents occupying the assigned virtual seat interacts to sell the product to the employee.

2. The computer-implemented method of claim 1, wherein the token data structure includes a n-bit data structure.

3. The computer-implemented method of claim 1, wherein the token data structure is configured to encode the employee, the employee's organization, one or more products available for sale and the qualifying information in a same manner across products, employees, organizations and sales agents.

4. The computer-implemented method of claim 1, wherein load balancing scheduler is configured to assign the encrypted token data structure to a plurality of virtual seats, and wherein a first available sales agent at one of the assigned virtual seats carries out a sale of the product to the employee.

5. The computer-implemented method of claim 1, wherein load balancing scheduler is configured to assign the encrypted token data structure to an available time slot in a calendar of a selected sales agent.

6. The computer-implemented method of claim 1, wherein generating, encrypting and sending are triggered by an action by the employee.

7. The computer-implemented method of claim 1, wherein generating, encrypting and sending are executed independently of an action by the employee.

8. The computer-implemented method of claim 1, further comprising updating the token data structure when the sales agents occupying the assigned virtual seat does sell the product to the employee in one interaction session.

9. A computing device, comprising:
a memory;
at least one processor;
a display;
a user interface; and
a plurality of processes spawned by the processor, the plurality of processes comprising processing logic to:
load information of a plurality of products, a plurality of employees of an organization and qualifying information for a plurality of sales agents into a database over a computer network;
generate a token data structure that is unique to a product of the plurality of products, to an employee of the plurality of employees and to qualifying information of at least one sales agent of the plurality of sales agents authorized to sell the product to the employee;
encrypt the generated token data structure;
send the encrypted token data structure to a load balancing scheduler over the computer network;
select, by the load balancing scheduler, a virtual seat of a plurality of available and qualified virtual seats, and assign the encrypted token data structure to the selected virtual seat, each qualified and available virtual seat being configured to be occupied by any available sales agent of the plurality of sales agents whose qualifying information matches the qualifying information in the generated token data structure;
decrypt the assigned token data structure; and
access the database over the computer network and loading information therefrom that is related at least to the product and the employee specified by the decrypted token data structure into an enrollment interface with which a sales agent of the plurality of sales agents occupying the assigned virtual seat interacts to sell the product to the employee.

10. The computing device of claim 9, wherein the token data structure includes a 256-bit data structure.

11. The computing device method of claim 9, wherein the token data structure is configured to encode the employee, the employee's organization, one or more products available for sale and the qualifying information in a same manner across products, employees, organizations and sales agents.

12. The computing device of claim 9, wherein load balancing scheduler is configured to assign the encrypted token data structure to a plurality of virtual seats, and wherein a first available sales agent at one of the assigned virtual seats carries out a sale of the product to the employee.

13. The computing device method of claim 9, wherein load balancing scheduler is configured to assign the encrypted token data structure to a an available time slot in a calendar of a selected sales agent.

14. The computing device of claim 9, wherein the processing logic for generating, encrypting and sending is triggered by an action by the employee.

15. The computing device of claim 9, wherein the processing logic for generating, encrypting and sending is executed independently of an action by the employee.

16. The computing device of claim 9, further comprising processing logic for updating the token data structure when the sales agents occupying the assigned virtual seat does sell the product to the employee in one interaction session.
